(19) United States
(12) Patent Application Publication
(10) Pub. No.: US 2021/0099513 A1
(43) Pub. Date: Apr. 1, 2021

(54) COMMUNICATION TERMINAL, COMMUNICATION SYSTEM, AND COMMUNICATION METHOD

(71) Applicant: Yoshihiro OGURA, Kanagawa (JP)

(72) Inventor: Yoshihiro OGURA, Kanagawa (JP)

(21) Appl. No.: 17/023,595

(22) Filed: Sep. 17, 2020

(30) Foreign Application Priority Data
Sep. 27, 2019 (JP) 2019-177978
Aug. 31, 2020 (JP) 2020-146276

(51) Int. Cl. H04L 29/08; G06F 3/0484

(52) U.S. Cl. CPC H04L 67/06; G06F 3/04845

(57) ABSTRACT

A communication terminal communicable with a server for managing inspection information of one or more inspection targets via a communication network, includes circuitry configured to acquire identification information identifying a particular inspection target from an information source associated with the particular inspection target; transmit the identification information to the server via the communication network; receive information on an input item related to an inspection result of the particular inspection target, transmitted from the server based on the identification information; display the input item on a display; and receive input information with respect to the input item.

### CROSS-REFERENCE TO RELATED APPLICATION

This application claims priority pursuant to 35 U.S.C. § 119(a) to Japanese Patent Application Nos. 2019-177978, filed on Sep. 27, 2019 and 2020-146276, filed on Aug. 31, 2020 in the Japan Patent Office, the disclosure of which are incorporated by reference herein in its entirety.

### BACKGROUND

### Technical Field

This disclosure relates to a communication terminal, a communication system, and a communication method.

### Background Art

Infrastructure maintenance and inspection works are performed periodically to inspect or check inspection targets, such as bridges and tunnels. Inspection works on structures at inspection sites are performed by inspectors having expertise and skills, and assistants, such as part-time assistants, who do not have expertise knowledge and skills.

Typically, the inspectors perform inspection works to determine the level of deterioration of inspection targets, and prepares assessment based on the inspection works while the assistants perform supporting or assisting the inspection works, such as inputting inspection results of inspection targets. For example, the assistants use communication terminals, such as smart devices, to upload the captured images and the inspection results of inspection targets to a server.

### SUMMARY

As one aspect of the present disclosure, a communication terminal communicable with a server for managing inspection information of one or more inspection targets via a communication network is devised. The communication terminal includes circuitry configured to acquire identification information identifying a particular inspection target from an information source associated with the particular inspection target; transmit the identification information to the server via the communication network; receive information on an input item related to an inspection result of the particular inspection target, transmitted from the server based on the identification information; display the input item on a display; and receive input information with respect to the input item.

As another aspect of the present disclosure, a communication system is devised. The communication system includes a communication terminal; and a server, communicable with the communication terminal via a communication network, configured to manage inspection information of one or more inspection targets. The communication terminal includes first circuitry configured to acquire identification information identifying a particular inspection target from an information source associated with a particular inspection target; transmit the identification information to the server via the communication network; receive information on an input item related to an inspection result of the particular inspection target, transmitted from the server based on the identification information; display the input item on a display; and receive input information with respect to the input item. The server includes second circuitry configured to store the identification information and information on the input item in association with each other; receive the identification information transmitted from the communication terminal via the communication network; and transmit, to the communication terminal via the communication network, information on a specific input item corresponding to the received identification information, by searching the information on the specific input item.

As another aspect of the present disclosure, a method of communicating information between a communication terminal communicable and a server for managing inspection information of one or more inspection targets via a communication network is devised. The method includes acquiring identification information identifying a particular inspection target from an information source associated with the particular inspection target; transmitting the identification information to the server via the communication network; receiving information on an input item related to an inspection result of the particular inspection target, transmitted from the server based on the identification information; displaying the input item on a display; and receiving input information with respect to the input item.

### BRIEF DESCRIPTION OF THE DRAWINGS

A more complete appreciation of the description and many of the attendant advantages and features thereof can be readily acquired and understood from the following detailed description with reference to the accompanying drawings, wherein:

FIG. 1 illustrates an example of system configuration of a communication system according to an embodiment;

FIG. 2 is an example of hardware block diagram of a smart device;

FIG. 3 is an example of hardware block diagram of a data management server, an inspection information management server, and a PC;

FIG. 4 is an example of functional block diagram of a communication system;

FIG. 5A is an example of data structure of access destination information;

FIG. 5B is an example of transfer destination management table;

FIG. 6A is an example of input item management table;

FIG. 6B is another example of input item management table;

FIG. 6C is another example of input item management table;

FIG. 7A is an example of inspection target image management table;

FIG. 7B is another example of inspection target image management table;

FIG. 7C is another example of inspection target image management table;

FIG. 8A is an example of inspection result management table;

FIG. 8B is another example of inspection result management table;

FIG. 8C is another example of inspection result management table;

FIG. 9 is an example of sequence diagram illustrating a process of requesting a registration screen of inspection result;

FIG. 10A is an example of confirmation screen displayable on a smart device;

FIG. 10B is an example of passcode input screen displayable on a smart device;

FIG. 11 is an example of sequence diagram illustrating a process of registering an inspection result;

FIG. 12 is an example of inspection result registration screen displayable on a smart device as an initial screen; and

FIG. 13 is an example of inspection result registration screen displayable on a smart device after inputting inspection information.

The accompanying drawings are intended to depict embodiments of the this disclosure and should not be interpreted to limit the scope thereof. The accompanying drawings are not to be considered as drawn to scale unless explicitly noted.

### DETAILED DESCRIPTION

A description is now given of exemplary embodiments of the present inventions. It should be noted that although such terms as first, second, etc. may be used herein to describe various elements, components, regions, layers and/or units, it should be understood that such elements, components, regions, layers and/or units are not limited thereby because such terms are relative, that is, used only to distinguish one element, component, region, layer or unit from another region, layer or unit. Thus, for example, a first element, component, region, layer or unit discussed below could be termed a second element, component, region, layer or unit without departing from the teachings of the present inventions.

In addition, it should be noted that the terminology used herein is for the purpose of describing particular embodiments only and is not intended to be limiting of the present inventions. Thus, for example, as used herein, the singular forms “a”, “an” and “the” are intended to include the plural forms as well, unless the context clearly indicates otherwise. Moreover, the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Hereinafter, a description is given of a communication system according to an embodiment in detail with reference to the drawings.

### (System Configuration)

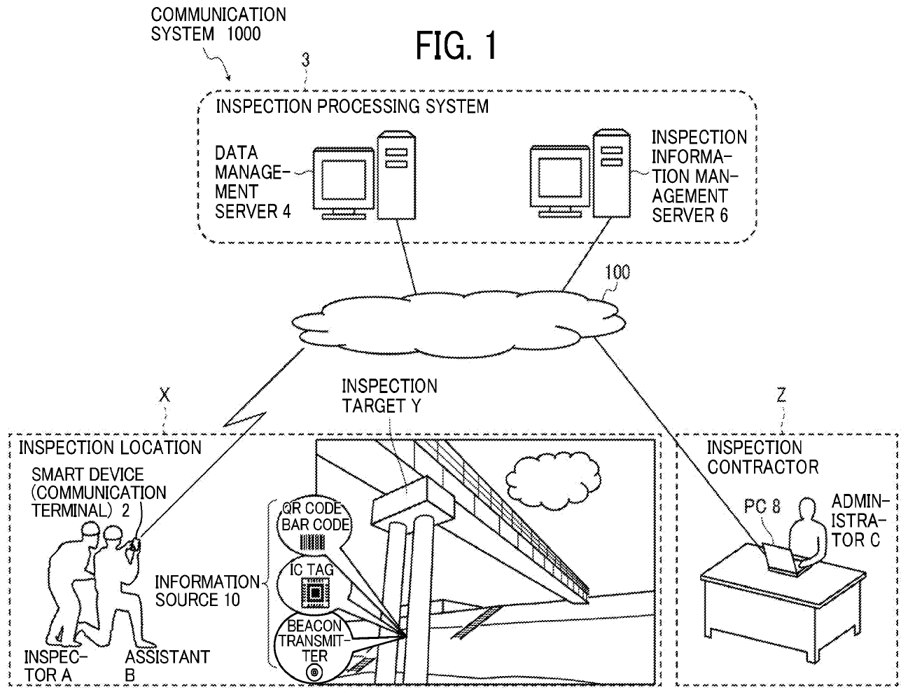

Hereinafter, a description is given of an outline of system configuration of a communication system 1000. FIG. 1 illustrates an example of system configuration of a communication system 1000 according to the embodiment.

As illustrated in FIG. 1, the communication system 1000 can be configured with, for example, a smart device 2 (communication terminal), a data management server 4, an inspection information management server 6, and a personal computer (PC) 8. Hereinafter, the smart device 2 may be also referred to as the smart phone, the data management server 4 may be also referred to as the data server, and the inspection information management server 6 may be also referred to as the inspection information server or the server for managing inspection information.

The smart device 2 can communicate with the data management server 4, the inspection information management server 6, and the PC 8 via a communication network 100. The communication network 100 is configured with the Internet, mobile communication network, local area network (LAN), or the like. The communication network 100 is not limited to the wired communication, but can be wireless communication networks, such as 3G (Third Generation), Worldwide Interoperability for Microwave Access (WiMAX: registered trademark), Long Term Evolution (LTE), or the like.

As illustrated in FIG. 1, when an inspector A inspects or checks an inspection target Y at an inspection location X (inspection site) periodically, and an assistant B requests a registration screen used for registering an inspection result of the inspection target Y, the smart device 2 acquires, from information source 10, information source identification (ID) identifying the information source 10 and universal resource locator (URL) as access destination to which the registration screen is requested.

The inspection target Y is, for example, structure such as bridge and tunnel, real estate building such as apartment and condominium, or movable apparatus such as vehicle, ship, and aircraft, but not limited thereto. The structures also includes, for example, piping or tubes used for transporting materials, such as gas, liquid, powder, and granular substance, and a vertical hole-shaped reinforced concrete structure object, such as a hoistway used as an elevator shaft in which a lift or an elevator travels.

The information source 10 includes, for example, a seal printed with given code information, such as quick response (QR) code and bar code, an integrated circuit (IC) tag, a beacon transmitter, or the like.

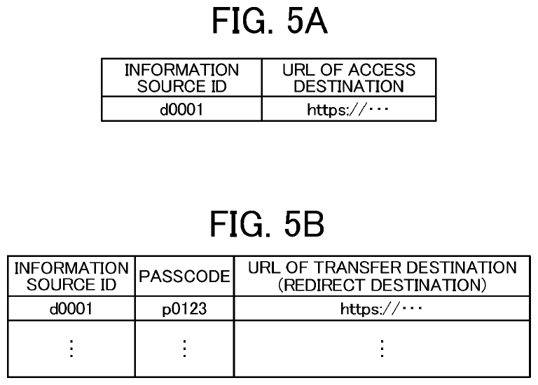

In a case of the QR code, as illustrated in FIG. 5A, various information, such as information source ID and URL as access destination, are embedded. When the seal having the QR code is attached to inspection target Y, the QR code and the inspection target Y are associated with each other. The smart device 2 acquires various information of the QR code using an application of QR code scanner installed on the smart device 2.

In a case of the IC tag, the smart device 2 is communicable using near-range communication technology, such as near field communication (NFC: registered trademark), Bluetooth (registered trademark) or the like with the IC tag. When the IC tag is attached to inspection target Y, the IC tag and the inspection target Y are associated with each other.

In a case of the beacon transmitter, when the smart device 2 enters a radio wave range of the beacon transmitter, the smart device 2 can communicate with the beacon transmitter using the radio wave originating from the beacon transmitter. When the beacon transmitter is attached to the inspection target Y, the beacon transmitter and the inspection target Y are associated with each other.

Further, the information source 10 is not required to be attached to the inspection target Y directly to associate the information source 10 and the inspection target Y. For example, the information source 10 may be attached or disposed at a position closer to the inspection target Y, compared to other inspection target existing in the vicinity of the inspection target Y.

Further, if a plurality of inspection targets exists at one site, the information source 10 corresponding to each one of plurality of inspection targets can be attached or set on one guide board in association with photo images and names of each one of plurality of structures.

As described above, the smart device 2 acquires various information from the information source 10, such as information source ID and uniform resource locator (URL) of access destination illustrated in FIG. 5A.

Then, the assistant B accesses the data management server 4 using the smart device 2, and requests a registration screen used for registering the inspection result of the inspection target Y. Then, the data management server 4 requests the registration screen to the inspection information management server 6. Then, the inspection information management server 6 transmits data of the registration screen to the smart device 2. Then, at the inspection location X, the assistant B captures latest images of the inspection target Y using the smart device 2, and inputs the inspection result to the input item under the instruction of the inspector A using the smart device 2. Further, the inspector A may perform the image capture operation and/or imputing of inspection result.

The smart device 2 uploads data, such as image data and inspection result of the inspection target Y, to the inspection information management server 6 to register the image data and the inspection result data of the inspection target Y in the inspection information management server 6. With this configuration, an administrator C of an inspection contractor Z can access the inspection information management server 6 from the PC 8 to acquire and view the images and the inspection results of the registered inspection target Y.

Further, the data management server 5 and the inspection information management server 6 are configured with a single or a plurality of computers. The data management server 4 and the inspection information management server 6 configure an inspection management system 3. The functions of the data management server 4 and the inspection information management server 6 can be included in the inspection management systems 3.

Further, the smart device 2 is an example of communication terminal, such as mobile or portable communication terminal. The communication terminal includes, for example, tablet PC, laptop PC, smartwatch, portable game machine, or the like.

### (Hardware Configuration)

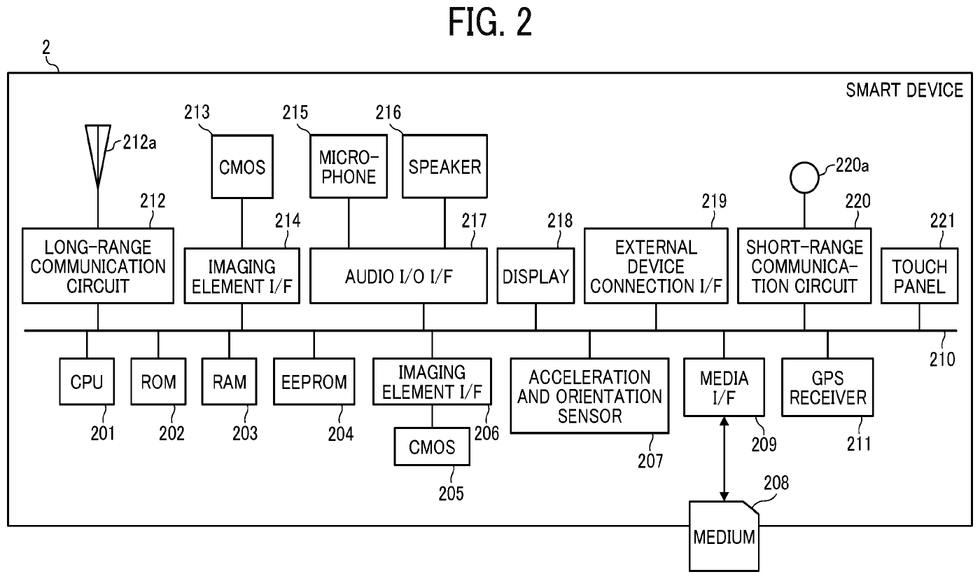

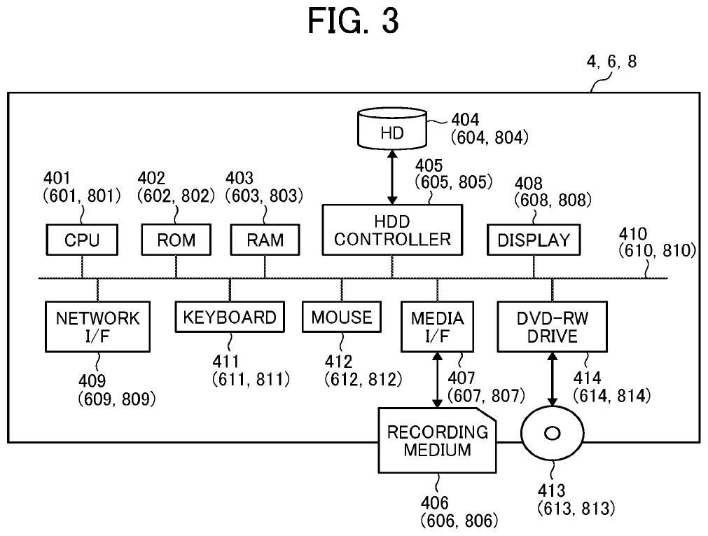

Hereinafter, with reference to FIGS. 2 and 3, a description is given of hardware configuration of the terminal and the server configuring the communication system 1000.

### (Hardware Configuration of Smart Device)

FIG. 2 is an example of hardware block diagram of the smart device 2. As illustrated in FIG. 2, the smart device 2 includes, for example, for example, a central processing unit (CPU) 201, a read-only memory (ROM) 202, a random access memory (RAM) 203, an electrically erasable programmable read-only memory (EEPROM) 204, a complementary metal oxide semiconductor (CMOS) 205, an imaging element interface (I/F) 206, an acceleration and orientation sensor 207, a media interface (I/F) 209, and a GPS receiver 211.

The CPU 201 controls the operation of the smart device 2 entirely. The ROM 202 stores programs used for driving the CPU 201, such as initial program loader (IPL). The RAM 203 is used as a work area of the CPU 201.

The EEPROM 204 reads and writes various data, such as programs for smart device under the control of the CPU 201. The complementary metal oxide semiconductor (CMOS) 205 is a built-in type image capture unit that captures images of objects (e.g., self-image) and acquires image data under the control of the CPU 201. Further, the charge coupled device (CCD) sensor can be an image capture means. The image element I/F 206 is a circuit that controls the driving of the CMOS 205.

The acceleration and orientation sensor 207 is various sensors such as an electronic magnetic compass, a gyrocompass, and an acceleration sensor to detect the geomagnetism. The media I/F 209 controls reading and writing (storing) of data to a recording medium 208, such as flash memory. The GPS receiver 211 receives GPS signals from GPS satellites.

As illustrated in FIG. 2, the smart device 2 further includes, for example, a long-range communication circuit 212, a CMOS 213, an imaging element interface (I/F) 214, a microphone 215, a speaker 216, an audio input/output I/F 217, a display 218, an external device connection interface (I/F) 219, a short-range communication circuit 220, an antenna 220a of the short-range communication circuit 220, and a touch panel 221.

The long-range communication circuit 212 is a circuit that communicates with other devices via the communication network 100.

The CMOS 213 is a built-in type image capture unit that captures images of object and acquires image data under the control of the CPU 201. The imaging element I/F 214 is a circuit for controlling the driving of the CMOS 213.

The microphone 215 is an integrated circuit that converts audio signals into electrical signals. The speaker 216 is an internal circuit that generates audio, such as music and audio sounds, by converting the electric signals to physical vibration. The audio input/output I/F 217 is a circuit that processes the input and output of audio signals with the microphone 215 and the speaker 216 under the control of the CPU 201.

The display 218 is a display unit, such as liquid crystal or organic electro luminescence (EL) display, which displays images of objects and various icons. The external device connection IF 219 is an interface for connecting various external devices. The short-range communication circuit 220 is a communication circuit, such as NFC or Bluetooth (registered trademark). The touch panel 221 is a type of input unit configured to operate the smart device 2 by pressing the display 218 by a user.

The smart device 2 further includes a bus line 210. The bus line 210 is an address bus and data bus for electrically connecting components illustrated in FIG. 2, such as the CPU 201.

### (Hardware Configuration of Data Management Server)

Hereinafter, with reference to FIG. 3, a description is given of hardware configuration of the data management server 4. FIG. 3 is an example of hardware block diagram of the data management server 4.

As illustrated in FIG. 3, the data management server 4, configured as computer, includes, for example, a CPU 401, a ROM 402, a RAM 403, a HD 404, a hard disk drive (HDD) controller 405, a media I/F 407, a display 408, a network I/F 409, a bus line 410, a keyboard 411, a mouse 412, and a digital versatile disk rewritable (DVD-RW) drive 414.

The CPU 401 controls the operation of the data management server 4 entirely. The ROM 402 stores programs used for driving the CPU 401, such as initial program loader (IPL). The RAM 403 is used as a work area of the CPU 401.

The HD 404 stores various data, such as programs. The HDD controller 405 controls reading and writing of various data to the HD 404 under the control of the CPU 401.

The display 408 displays various information, such as cursor, menu, window, characters, and image. The media I/F 407 controls reading and writing (storing) of data to a recording medium 415, such as flash memory.

Further, the network I/F 409 is an interface for data communication using the communication network 100. The bus line 410 is an address bus and a data bus for electrically connecting each component illustrated in FIG. 3, such as the CPU 401.

Further, the keyboard 411 is a type of input unit including a plurality of keys for inputting, such as characters, numbers, and various instructions. The mouse 412 is a type of input unit used for selecting various instructions, performing various instructions, selecting process target, moving a cursor, or the like.

The DVD-RW drive 414 controls reading and writing of various data to DVD-RW 413, which is an example of removable recording medium.

Further, instead of DVD-RW, DVD-R or Blu-ray Disc (registered trademark) can be used. The same applies to the inspection information management server 6 and the PC 8.

### (Hardware Configuration of Inspection Information Management Server)

Hereinafter, with reference to FIG. 3, a description is given of hardware configuration of the inspection information management server 6. FIG. 3 also illustrates a hardware configuration of the inspection information management server 6.

As illustrated FIG. 3, the inspection information management server 6, configured as computer, includes, for example, a CPU 601, a ROM 602, a RAM 603, a HD 604, a HDD controller 605, a media I/F 607, a display 608, a network I/F 609, a bus line 610, a keyboard 611, a mouse 612, and a DVD-RW drive 614.

Since these components employ the same configurations as those of the CPU 401, the ROM 402, the RAM 403, the HD 404, the HDD controller 405, the media I/F 407, the display 408, the network I/F 409, the bus line 410, the keyboard 411, the mouse 412, and the DVD-RW drive 414, the descriptions of thereof are omitted.

Further, as to the inspection information management server 6, the media I/F 607 controls reading and writing (storing) of data to a recording medium 615, such as flash memory. The DVD-RW drive 614 controls reading and writing of various data to a DVD-RW 613, which is an example of removable recording medium.

### (Hardware Configuration of PC)

Hereinafter, with reference to FIG. 3, a description is given of hardware configuration of the PC 8. FIG. 3 also illustrates a hardware configuration of the PC 8.

As illustrated FIG. 3, the PC 8, configured as computer, includes, for example, a CPU 801, a ROM 802, a RAM 803, a HD 804, a HDD controller 805, a media I/F 807, a display 808, a network I/F 809, a bus line 810, a keyboard 811, a mouse 812, and a DVD-RW drive 814.

Since these components employ the same configurations as those of the CPU 401, the ROM 402, the RAM 403, the HD 404, the HDD controller 405, the media I/F 407, the display 408, the network I/F 409, the bus line 410, the keyboard 411, the mouse 412, and the DVD-RW drive 414, the descriptions of thereof are omitted.

As to the PC 8, the media I/F 807 controls reading and writing (storing) of data to a recording medium 815, such as flash memory. The DVD-RW drive 814 controls reading and writing of various data to DVD-RW 813, which is an example of removable recording medium.

### (Functional Configuration of Communication System)

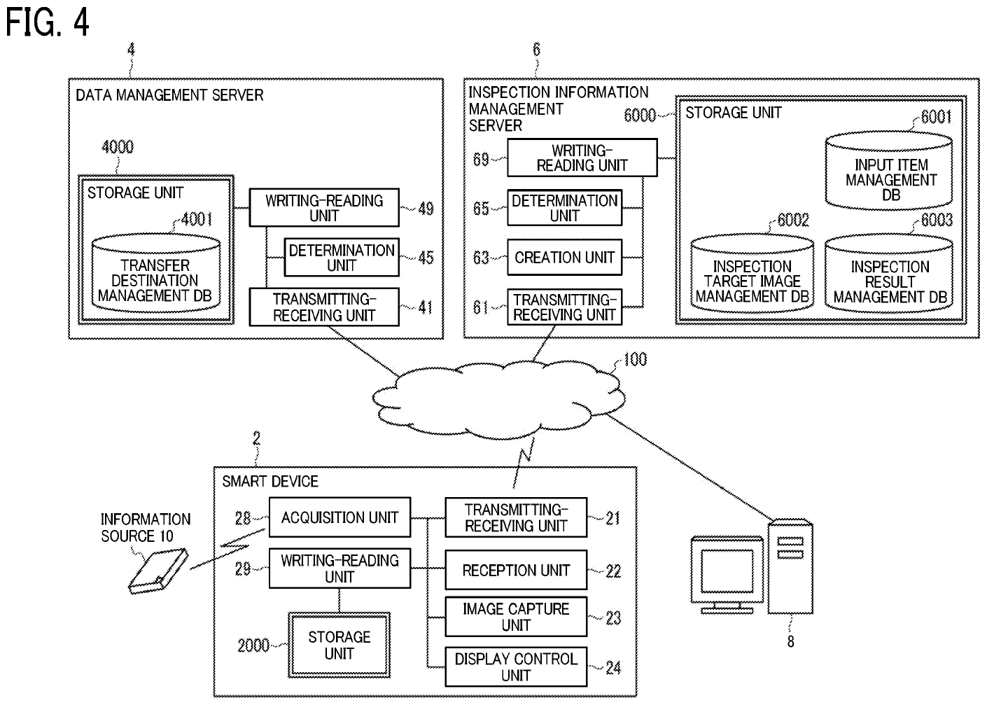

Hereinafter, with reference to FIGS. 2 and 4, a description is given of functional configuration of the embodiment. FIG. 4 is a functional block diagram of a communication system 1000.

### (Functional Configuration of Smart Device)

Hereinafter, with reference to FIG. 4, a description is given of functional configuration of the smart device 2. As illustrated in FIG. 4, the smart device 2 includes, for example, transmitting-receiving unit 21, reception unit 22, image capture unit 23, display control unit 24, communication unit 28, and writing-reading unit 29. Each of these functions is a function or functional unit that is implemented by operating any one of the components of FIG. 2 under the instruction from the CPU 201 executing the programs for the smart device loaded on the RAM 203 from the EEPROM 204. The smart device 2 further includes a storage unit 2000, implemented by the RAM 203 and the EEPROM 204 illustrated in FIG. 2.

### (Functional Configuration of Smart Device)

Hereinafter, with reference to FIG. 4, a description is given of functional configuration of the smart device 2 in detail.

The transmitting-receiving unit 21, implemented by an instruction from the CPU 201 illustrated in FIG. 2, communicates with other device (e.g., server, terminal) via the communication network 100.

The reception unit 22, implemented by an instruction from the CPU 201, receives, for example, a selection by a user (e.g., assistant B) via the touch panel 221. The image capture unit 23, implemented by the CMOS 205 and the imaging element I/F 206, or the CMOS 213 and the imaging element I/F 214 by an instruction from the CPU 201.

The display control unit 24, implemented by an instruction from the CPU 201, displays various screens (e.g., images, characters) on the display 218.

The acquisition unit 28, implemented by an instruction from the CPU 201, performs short-range communication with the information source 10, such as IC tag or beacon transmitter, via the short-range communication circuit 220 and the antenna 222a.

The writing-reading unit 29, implemented by an instruction from the CPU 201, performs a process of writing various data to the storage unit 2000 and reading various data stored in the storage unit 2000.

### (Functional Configuration of Data Management Server)

Hereinafter, with reference to FIG. 4, a description is given of functional configuration of the data management server 4. As illustrated in FIG. 4, the data management server 4 includes, for example, transmitting-receiving unit 41, determination unit 45, and writing-reading unit 49. Each of these functions is a function or functional unit that is implemented by operating any one of the components of FIG. 3 under the instruction from the CPU 401 executing the programs for the server loaded on the RAM 403 from the HD 404. Further, the data management server 4 includes a storage unit 4000, implemented by the RAM 403 and the HD 404 illustrated in FIG. 3.

### (Transfer Destination Management Table)

FIG. 5B illustrates an example of transfer destination management table. The storage unit 4000 stores a transfer destination management database (DB) 4001 including the transfer destination management table illustrated in FIG. 5B. The transfer destination management table stores various information, such as information source ID, passcode, uniform resource locator (URL) of transfer destination (redirect destination) in association with each other.

The information source ID is information provided by the information source 10 to the communication terminal such as the smart device 2. The information source ID is an information source identifying information (an example of identification information) identifying the information source 10.

The passcode is a string of characters and numbers used for authenticating each user (e.g., inspector A, assistant B) or the smart device 2. The passcode is an example of authentication information. The authentication information may also include a password. Further, if the attribute name (e.g., information source ID) are the same in various tables to be described in this disclosure, the same attribute name means the same content.

### (Functional Configuration of Data Management Server)

Hereinafter, with reference to FIG. 4, a description is given of functional configuration of the data management server 4 in detail.

The transmitting-receiving unit 41, implemented by an instruction from the CPU 401 illustrated in FIG. 3, communicates with other device (e.g., server, terminal) via the communication network 100.

The determination unit 45, implemented by an instruction from the CPU 401 illustrated in FIG. 3, performs various determinations.

The writing-reading unit 49, implemented by an instruction from the CPU 401, performs a process of writing various data to the storage unit 4000 and reading various data stored in the storage unit 4000.

### (Functional Configuration of Inspection Information Management Server)

Hereinafter, with reference to FIG. 4, a description is given of functional configuration of the inspection information management server 6. As illustrated in FIG. 4, the inspection information management server 6 includes, for example, transmitting-receiving unit 61, creation unit 63, determination unit 65, and writing-reading unit 69. Each of these functions is a function or functional unit that is implemented by operating any one of the components of FIG. 3 under the instruction from the CPU 601 executing the programs for the server loaded on the RAM 603 from the HD 604. Further, the inspection information management server 6 includes a storage unit 6000, implemented by the RAM 603 and the HD 604 illustrated in FIG. 3.

### (Input Item Management Table)

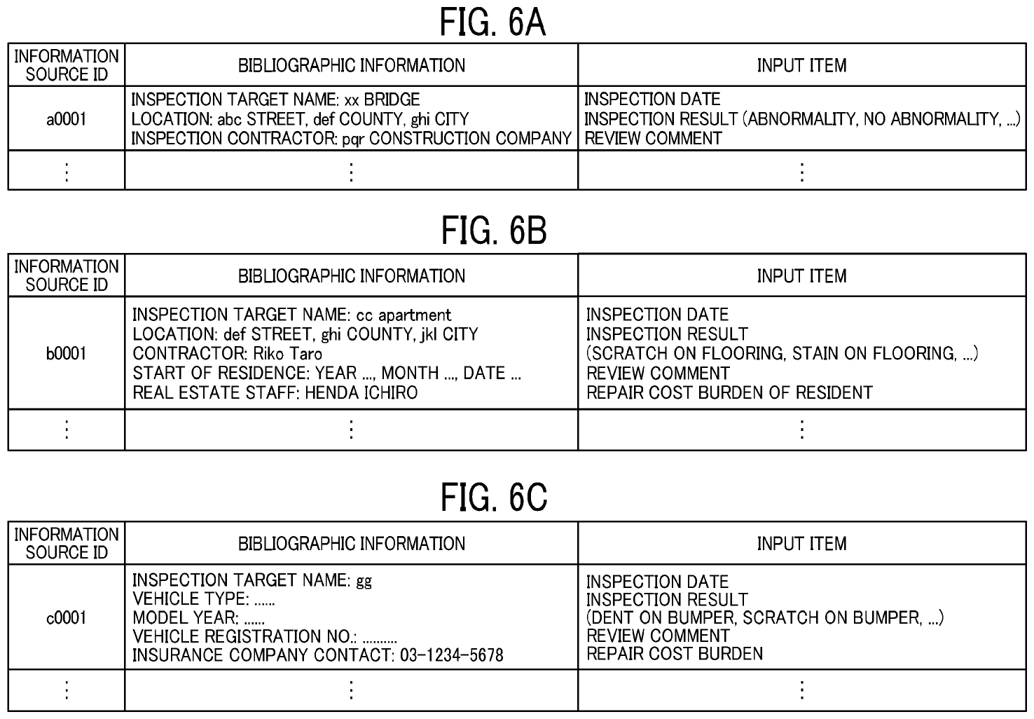

FIG. 6 illustrates an example of input item management table. The storage unit 6000 stores input item management database (DB) 6001 including the input item management table illustrated in FIG. 6A.

FIG. 6A is an input item management table for structure, such as bridge, tunnel, or the like.

FIG. 6B is an input item management table for real estate building, such as apartment and condominium.

FIG. 6C is an input item management table for movable apparatus, such as vehicle, ship, and aircraft.

The input item management table stores various information, such as information source ID, bibliographic information, and input item in association with each other. The input item includes one or more pieces of information. In FIGS. 6A, 6B and 6C, the bibliographic information and input item corresponding to three types of inspection targets are indicated. However, these three types of inspection targets are just examples of inspection targets, and are not limited thereto.

In FIG. 6A, the head letter “a” of the information source ID is an example of a code indicating that the type of the inspection target is a structure.

In FIG. 6B, the head letter “b” of the information source ID is an example of a code indicating that the type of the inspection target is a real estate building.

In FIG. 6C, the head letter “c” of the information source ID is an example of a code indicating that the type of the inspection target is a movable apparatus.

Further, the head letter of the information source ID means the same for tables to be escribed below.

The bibliographic information indicates bibliographic information on each inspection target. The bibliographic information includes various information, such as inspection target name, location of inspection target, and inspection contractor assigned to inspect the inspection target.

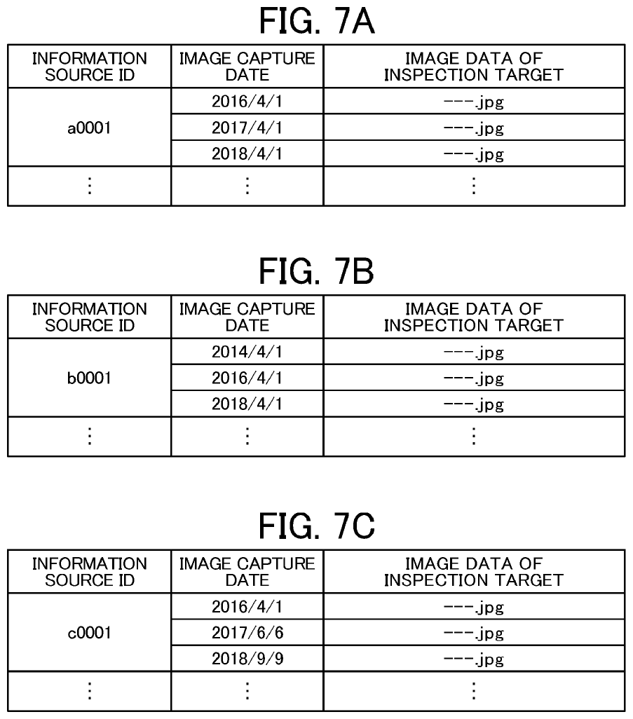

Each input item is an item for inputting information on an inspection result of the inspection target Y subject to be inspected. The item of “inspection result” is registered with options, such as “abnormality” and “no abnormality” so that a user (inspector or assistant) can easily input the inspection result. Each of the bibliographic information and the input item is registered by the administrator C from the PC 8 by accessing the inspection information management server 6 in advance, prior to step S21 of FIG. 7.

### (Inspection Target Image Management Table)

FIGS. 7A, 7B, and 7C are examples of inspection target image management table. The storage unit 6000 stores an inspection target image management DB 6002 (input item management unit) storing the inspection target image management table illustrated in FIGS. 7A, 7B, and 7C. As similar to FIGS. 6A, 6B, and 6C, FIG. 7A is an inspection target image management table for structure, FIG. 7B is an inspection target image management table for real estate building, and FIG. 7C is an inspection target image management table for movable apparatus. Each inspection target image management table stores various information, such as information source ID, image capture date, and image data of inspection target in association with each other.

The image capture date indicates a date on which an image of inspection target was captured by the smart device 2. The image data of inspection target is image data of each inspection target captured and acquired on the image capture date. In this example case, the image capture date indicates that the inspection has been performed every year. Further, a plurality of image data of the inspection target can be associated with one image capture date.

### (Inspection Result Management Table)

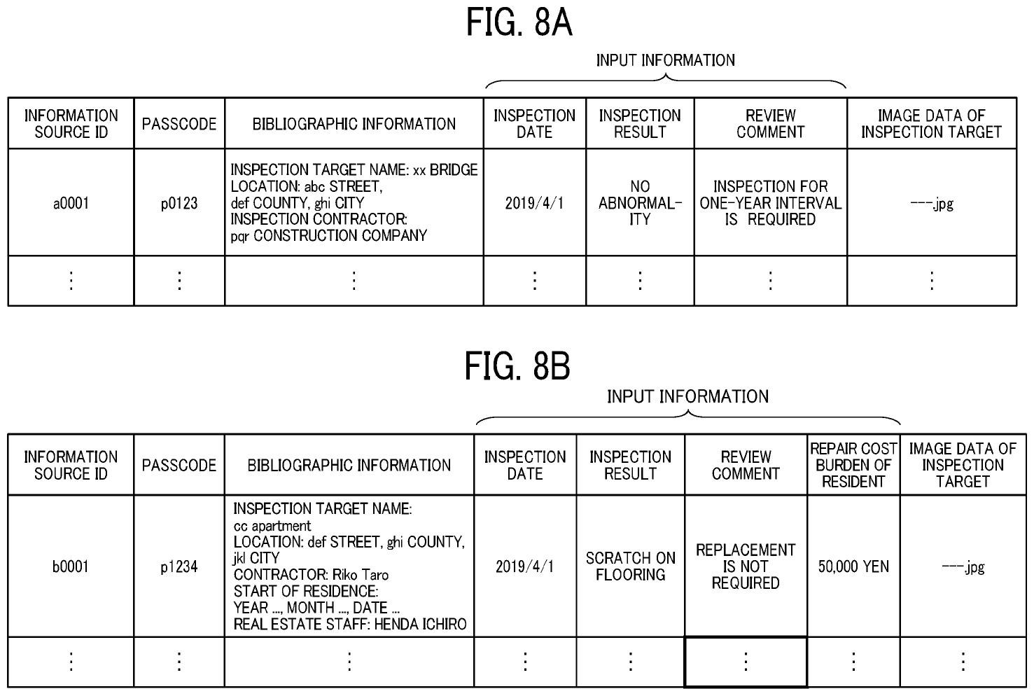

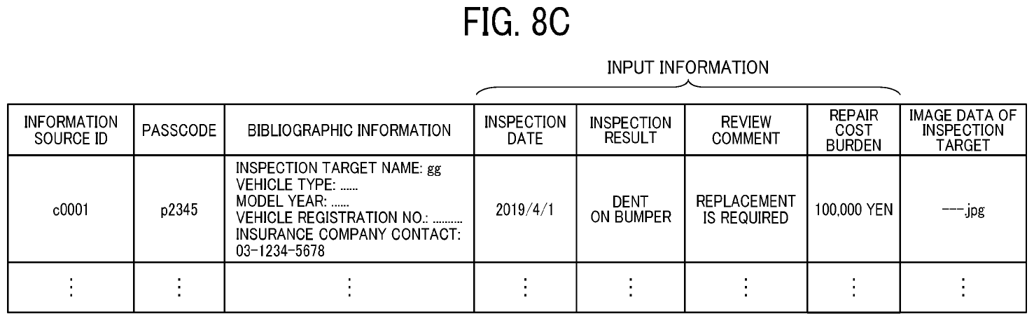

FIGS. 8A, 8B, and 8C are examples of inspection result management table. The storage unit 6000 stores an inspection result management DB 6003 (input item management unit) storing the inspection result management table illustrated in FIGS. 8A, 8B, and 8C. As similar to FIGS. 6A, 6B, and 6C, FIG. 8A is an inspection target image management table for structure, FIG. 8B is an inspection target image management table for real estate building, and FIG. 8C is an inspection target image management table for movable apparatus. Each inspection result management table stores various information, such as information source ID, passcode, bibliographic information, input information (e.g., inspection date, inspection result, review comment), and image data of inspection target in association with each other.

The inspection date indicates a date on which the inspection target Y was inspected by the inspector A and the assistant B. Since the image of the inspection target Y is captured on the inspection date, the inspection date is typically the same as the image capture date.

The inspection result is an inspection result of the inspection target Y determined by the inspector A.

The review comment is a comment on the inspection result of the inspection target Y determined by the inspector A.

Further, a plurality of image data of the inspection target Y can be associated with one inspection date (image capture date).

Further, in a case of the inspection result management table for real estate building indicated in FIG. 8B, the input information includes a column of repair cost burden of resident (i.e., compensation amount of resident).

Further, in a case of the inspection result management table for movable apparatus indicated in FIG. 8C, the input information includes repair cost of owner (i.e., compensation amount of owner).

### (Functional Configuration of Inspection Information Management Server)

Hereinafter, with reference to FIG. 4, a description is given of functional configuration of the inspection information management server 6 in detail.

The transmitting-receiving unit 61, implemented by an instruction from the CPU 601 illustrated in FIG. 3, communicates with other device (e.g., server, terminal) via the communication network 100.

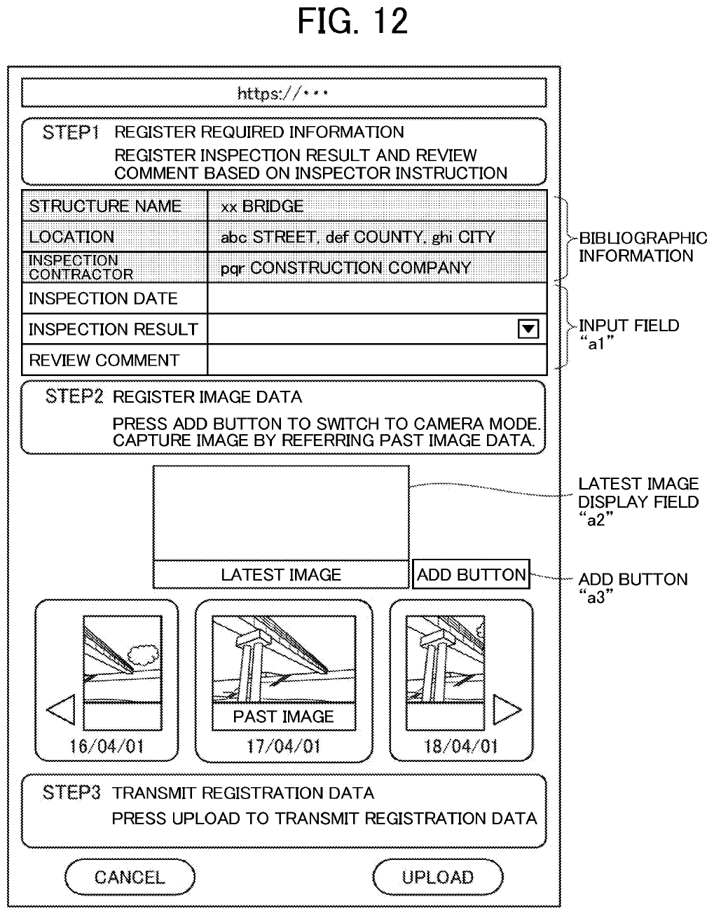

The creation unit 63, implemented by an instruction from the CPU 601 illustrated in FIG. 3, creates data on an inspection result registration screen, to be described later with reference to FIG. 12.

The determination unit 65, implemented by an instruction from the CPU 601 illustrated in FIG. 3, performs various determinations.

The writing-reading unit 69, implemented by an instruction from the CPU 601, performs a process of writing various data to the storage unit 6000 and reading various data stored in the storage unit 6000.

### (Processing and Operation)

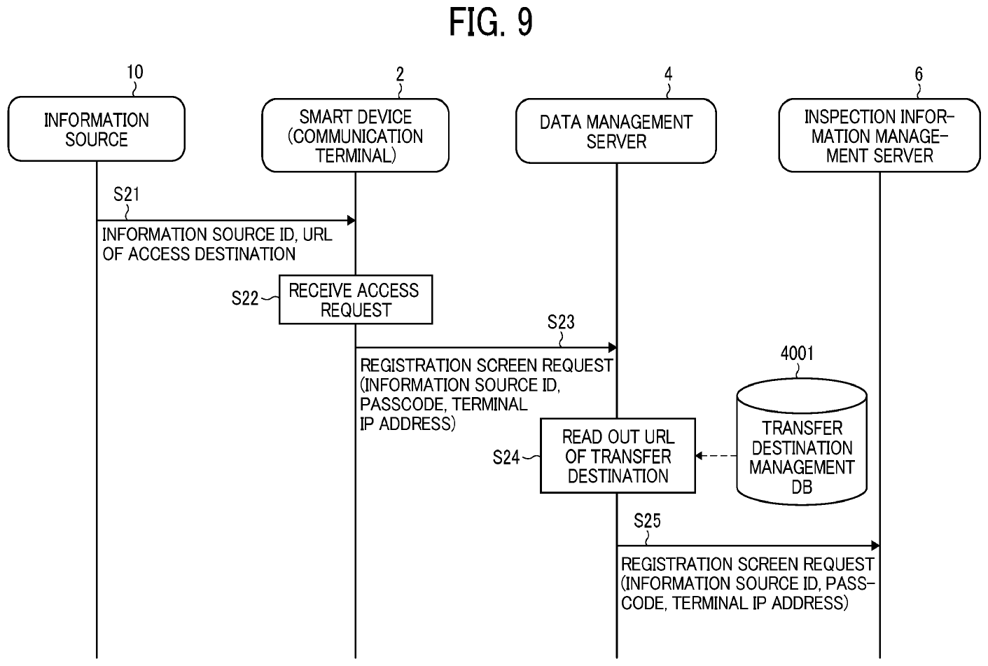

Hereinafter, with reference to FIG. 1, and 9 to 13, a description is given of processing and operation of the embodiment. As illustrated in FIG. 1, a case where the inspector A and the assistant B have visited the inspection location X and approached the information source 10 of the inspection target Y (i.e., target of inspection) is described. FIG. 9 is an example of sequence diagram illustrating a process of requesting a registration screen of inspection result.

### (Request of Registration Screen of Inspection Result)

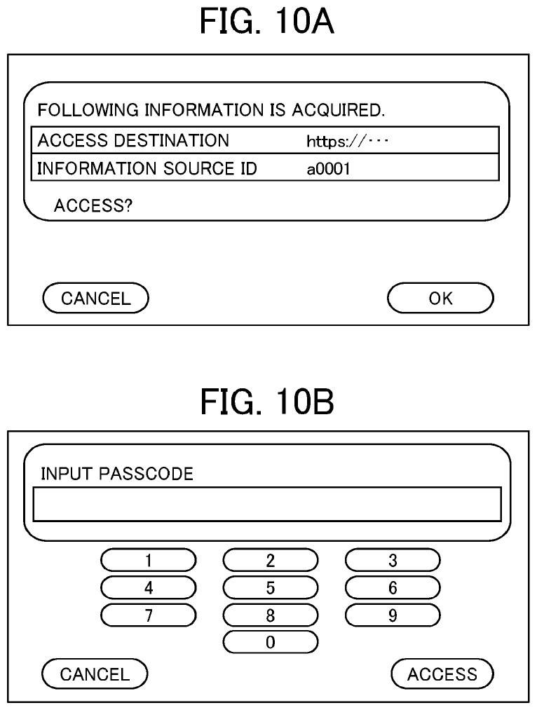

Hereinafter, with reference to FIGS. 9 and 10, a description is given of request processing of the registration screen of inspection result.

When the assistant B approaches the information source 10 of the inspection target Y (i.e., target of inspection), the acquisition unit 28 of the smart device 2, carried by the assistant B, acquires the information source ID and the URL of access destination (see FIG. 5A) from the information source 10 (step S21). Then, the display control unit 24 displays a confirmation screen illustrated in FIG. 10A on the display 408. FIG. 10A illustrates an example of confirmation screen displayable on the smart device 2.

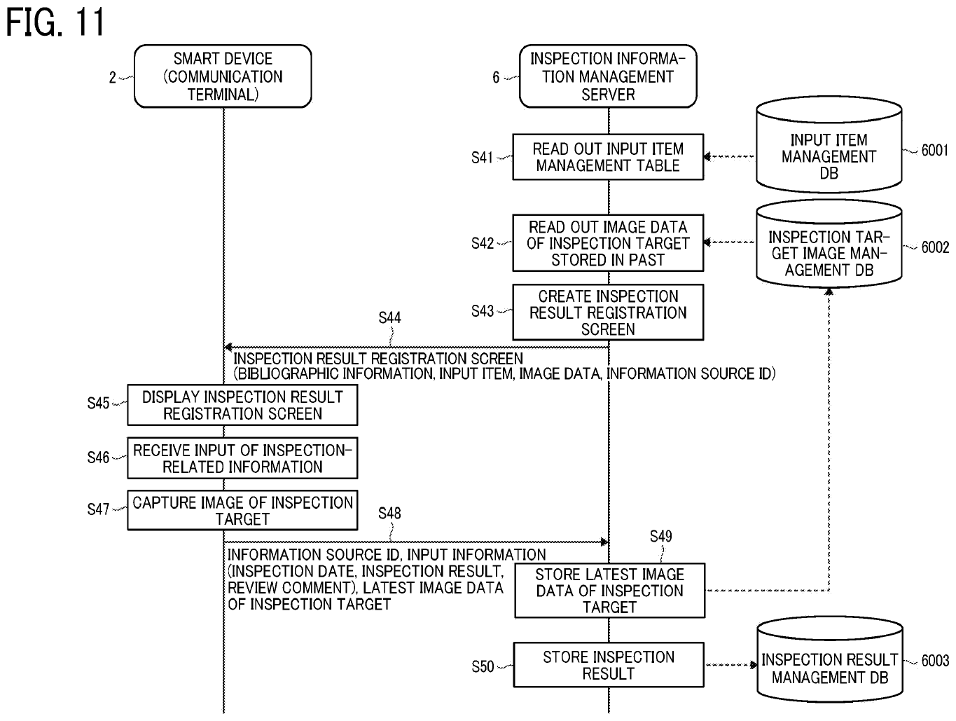

Then, the reception unit 22 receives an access request to the access destination from the assistant B (step S22). As above described, the smart device 2 acquires the URL of the access destination and then accesses the URL, with which, in steps S44 to S48 to be described later with reference to FIG. 11, a web browser installed on the smart device 2 can display an inspection result registration screen, receive an input of inspection result, and transmit image data.

With reference to FIGS. 10A and 10B, step S22 is described in detail. FIG. 10B illustrates an example of passcode input screen displayable on the smart device 2.

As to the confirmation screen illustrated in FIG. 10A, an upper part of the confirmation screen displays the information source ID and the URL of access destination received in step S21 from the information source 10. Further, the confirmation screen displays “OK” button and “CANCEL” button at the bottom of the confirmation screen. In this example case, if the assistant B presses the OK button, the reception unit 22 receives a selection of the OK button, and then the display control unit 24 switches a display to the passcode input screen illustrated in FIG. OB.

As illustrated in FIG. 10B, the passcode input screen displays a passcode input field at the upper part, a numeric keypad at the middle part, and “ACCESS” button and “CANCEL” button at the bottom part of the passcode input screen. If the assistant B presses the numeric keypad to input a passcode, and then presses the “ACCESS” button, the reception unit 22 receives the access request to the access destination. If the assistant B presses the CANCEL button illustrated in FIGS. 10A and 10B, the reception unit 22 does not receive the access request to the access destination.

Then, when the reception unit 22 receives the pressing of “ACCESS” button, the transmitting-receiving unit 21 transmits a registration screen request indicating a request of the registration screen used for registering the inspection result of inspection target to the data management server 4 based on the URL of the access destination acquired in step S21 (step S23).

The registration screen request includes, for example, the information source ID acquired in step S21, the passcode and the terminal IP address indicating the IP address of the smart device 2 received in step S22. Then, the transmitting-receiving unit 41 of the data management server 4 receives the registration screen request.

Further, the information source ID includes a head letter, such as “a” (see FIG. 6A) as a code indicating that a type of the inspection target is a structure, but is not limited thereto. For example, the information source 10 can be configured to store the code indicating the type (example of type information) separately from the information source ID (e.g., “0001” in FIG. 6A), in which the transmitting-receiving unit 21 may transmit the information source ID with the code indicating the type.

Further, the transmitting-receiving unit 21 does not necessarily have to transmit the IP address of the smart device 2. By transmitting the IP address, the smart device 2 can perform a bidirectional communication (e.g., real-time check, chat bot) with the PC 8 used by the administrator C at a later stage.

Then, at the data management server 4, the writing-reading unit 49 uses a combination of the information source ID and the passcode received in step S23 as a search key to search the transfer destination management DB 4001 to read out a URL of the corresponding transfer destination (step S24). The processing of step S24 also serves as an authentication processing of the smart device 2.

Then, the transmitting-receiving unit 41 transfers the registration screen request to the inspection information management server 6 based on the read-out URL of the transfer destination (step S25). The transferred registration screen request includes, for example, the information source ID, the passcode, and the terminal IP address received in step S23. In step S25, the transmitting-receiving unit 61 of the inspection information management server 6 receives the transferred registration screen request.

### (Registration of Inspection Result)

Hereinafter, with reference to FIGS. 11 to 13, a description is given of registration processing of the inspection result. FIG. 11 is an example of sequence diagram illustrating a process of registering the inspection result.

When the inspection information management server 6 receives the registration request in step 25 (FIG. 9), as illustrated in FIG. 11, the writing-reading unit 69 of the inspection information management server 6 uses the information source ID received in step S25 as a search key to search the input item management DB 6001 to read out a particular input item management table corresponding to a particular type (step S41).

In this case, the type of the input item management table is narrowed, at first, to a particular type (e.g., structure) based on the head letter of the information source ID (e.g., “a”) (primary narrowing), and then further narrowed to a particular input item management table for a particular inspection target (e.g., bridge) based on information subsequent to the head letter of the information source ID to extract the particular input item management table for the particular inspection target (secondary narrowing). The secondary narrowing is performed, for example, when two or more inspection targets, such as bridge and tunnel, use the same input item.

As indicated in an example case of FIG. 6A, the head letter “a” of the information source ID indicates that the type is “structure,” and the information “0001” subsequent to the head letter “a” of the information source ID indicates that the particular inspection target is “bridge.”

Further, the search can be completed by narrowing the particular type of the input item management table alone. For example, when the same input item is used for the bridge and tunnel set as the inspection targets, the secondary narrowing is not required.

Further, the search can be completed by directly narrowing the particular input item management table (secondary narrowing) without narrowing the particular type (primary narrowing). For example, the search can be completed by directly narrowing the particular input item management table (secondary narrowing) when different input items are used for a large bridge and a small bridge set as the inspection targets.

Then, the writing-reading unit 69 uses the information source ID received in step S25 as a search key to search the inspection target image management DB 6002 to read out a specific set of image data of inspection target of corresponding image capture date and image data of corresponding inspection target stored in the past (step S42). In step S42, the specific set of image data of inspection target is read out by performing the narrowing as similar to step S41.

Further, the writing-reading unit 69 can be configured to read out the specific set of image data of inspection target of corresponding image capture date (inspection date) and image data of corresponding inspection target stored in the past, which correspond to the information source ID, from the inspection result management DB 6003 instead of the inspection target image management DB 6002. In this case, the inspection target image management DB 6002 can be omitted.

Then, the creation unit 63 creates data of inspection result registration screen, to be described later in FIG. 12, based on the information read out in step S41 and the image data read out in step S42 (step S43).

FIG. 12 is an example of inspection result registration screen displayable on the smart device 2 as an initial screen. The inspection result registration screen is an example of screen displayable on the communication terminal, such as the smart device 2.

Then, the inspection information management server 6 transmits the data of inspection result registration screen, created in step S43, to the smart device 2, which is a request source of the registration screen (step S44). The data of inspection result registration screen includes the bibliographic information and input item read out in step S41, the image data read out in step S42, and the information source ID received in step S25.

Then, in response to receiving the data of inspection result registration screen in step S44, at the smart device 2, the display control unit 24 instructs the display 218 to display the inspection result registration screen illustrated in FIG. 12 using a web browser (step S45).

Hereinafter, with reference to FIG. 12, a description is given of the inspection result registration screen displayed on the smart device 2 as an initial screen. In FIG. 12, the inspection result registration screen is a screen for the bridge, which is an example of the inspection target.

As illustrated in FIG. 12, the inspection result registration screen displayed as the initial screen displays, for example, the URL of the inspection result registration screen, and instruction sections of “STEP1, STEP2, and STEP3.” A user (e.g., assistant B) processes in accordance with the instructions displayed in “STEP1, STEP2, and STEP3.”

The section of “STEP1” displays, for example, the bibliographic information, such as structure name (inspection target name), location, and inspection contractor (name). Further, the section of “STEP1” displays an input field “a1” used for inputting the input item related to the inspection information, such as inspection date, inspection result, and review comment. The inspection result can be selected by a pull-down menu or the like.

Further, the “inspection date” can be displayed as the bibliographic information in advance. In this case, the inspection date is also registered in advance as similar to the inspection target name, and the inspection date indicates “expected inspection date.” The section of “STEP2” displays the past images of the inspection target Y, which is the current inspection target, from the beginning. The past images are received in step S44. Further, the section of “STEP2” displays a latest image display field “a2,” and an add button “a3.” The latest image display field “a2” is used to display the latest image of the inspection target Y to be captured by the assistant B. The add button “a3” is a button used for switching from the inspection result registration screen being displayed currently to an image capture screen.

Further, instead of the add button “a3,” a sample image can be displayed in the latest screen display field “a2,” and the sample image can be used as a trigger to switch the display screen from the inspection result registration screen, being displayed currently, to the image capture screen. In this case, the add button “a3” is used as a button that is to be pressed at the time of the second and subsequent image capture operations.

Further, the section of “STEP3” displays “UPLOAD” button and “CANCEL” button. The “UPLOAD” button is a button used for uploading each data input in “STEP1” and “STEP2” to the inspection information management server 6. The CANCEL button is a button used for cancelling the uploading of data.

At first, the assistant B checks the bibliographic information in the section of “STEP1” displayed on the inspection result registration screen. Then, the reception unit 22 receives an input of inspection-related information, such as inspection date, inspection result, and review comment in the input field “a1,” performed by the assistant B (step S46). Since the inspection result and the determination of the review comment require expert knowledge, the assistant B inputs the inspection result and the determination of the review comment under the instruction of the inspector A.

Further, since the inspection result can be selected by a pull-down menu or the like, the assistant B selects the inspection result under the instruction of the inspector A. Further, since the review comment can be input or described freely, the assistant B inputs the review comment under the instruction of the inspector A.

Then, the sequence proceeds to “STEP2,” in which the inspector A and the assistant B refer to the past images of the inspection target to determine photography composition of the same inspection target to be captured at the current time.

Then, after the reception unit 22 receives the pressing of the add button “a3” performed by the assistant B, the display control unit 24 switches the display screen from the inspection result registration screen (see FIG. 12) to the image capture screen, and then if the reception unit 22 receives an image capture operation performed by the assistant B, the image capture unit 23 captures an image of an inspection target, which is the current inspection target (step S47). Then, the display control unit 24 displays the image of the inspection target acquired by performing the image capture operation on the latest image display field “a2.”

Further, the image capture operation can be performed for a plurality of times while displaying the image capture screen, or the image capture operation can be performed for a plurality of times by returning to the inspection result registration screen after the end of the first image capture operation, receiving the pressing of the add button “a3” at the reception unit 22 again, and then displaying the image capture screen again. In this case, the latest image display field “a2” displays a plurality of the latest images of the inspection target, and then the assistant B consults the inspector A to select a specific image.

Then, the sequence proceeds to “STEP3.” If the reception unit 22 receives the pressing of “UPLOAD” button performed by the assistant B, the transmitting-receiving unit 21 transmits the information source ID, the input information (e.g., inspection date, inspection result, review comment), and the latest image data of the inspection target to the inspection information management server 6 (step S48). The information source ID is the information received in step S44, and is used to associate a series of processes. The input information is the information input in step S46. The latest image data of the inspection target is image data of the inspection target obtained or acquired by capturing the image of the inspection target in step S47. In step S48, the transmitting-receiving unit 61 of the inspection information management server 6 receives the information source ID, the input information, and the latest image data of the inspection target.

Further, if the image capture operation was performed for a plurality of times, among a plurality of the latest image data of the inspection target, the smart device 2 transmits at least one image selected by the assistant B to the inspection information management server 6 in step S48.

In this case, prior to step S48, the display control unit 24 displays a plurality of the latest images of the inspection target (e.g., thumbnail images), and then the reception unit 22 receives the selection of the desired image performed by the assistant B.

Alternatively, prior to step S48, the display control unit 24 can display a plurality of the latest images of the inspection target (e.g., thumbnail images) one by one, and then displays a screen prompting the assistant B to select whether or not to upload each image. Then, the reception unit 22 receives the selection of uploading or not from the assistant B for each image.

Further, the smart device 2 does not need to perform step S48. In this case, the inspector A or assistant B may later bring the smart device 2 near the inspection information management server 6, and then the contents transmitted in step S48 can be transferred to the inspection information management server 6 using a universal serial bus (USB) cable connecting the smart device 2 and the inspection information management server 6, or USB memory.

Then, at the inspection information management server 6, the writing-reading unit 69 uses the information source ID received in step S48 as a search key to search the inspection target image management DB 6002 to store the inspection date, received in step S48, in a data recording column used for recording image capture date of the corresponding inspection target, and store the latest image data of inspection target, received in step S48, in a data recording column of used for recording image data of the corresponding inspection target (step S49).

Further, if the information source ID received in step S48 is not yet stored in the inspection target image management DB 6002, the writing-reading unit 69 newly stores the information source ID, the image capture date (inspection date), and the latest image data of the inspection target received in step S48 in association with each other in the inspection target image management DB 6002. Further, if the information on the image capture date is attached as metadata of the latest image data of the inspection target, the attached information on the image capture date may be stored as the image capture date in the inspection target image management DB 6002.

Then, the writing-reading unit 69 stores the information received in step S25 (i.e., information source ID, passcode), the bibliographic information read out in step S41, and the inspection-related information (i.e., inspection date, review comment, latest image data of inspection target) received in step S48 in association with each other in the inspection result management DB 6003 as a new record (step S50).

Further, the writing-reading unit 69 may not need to store the passcode. In this case, in step S25 (FIG. 9), the data management server 4 is not required to transfer the passcode to the inspection information management server 6.

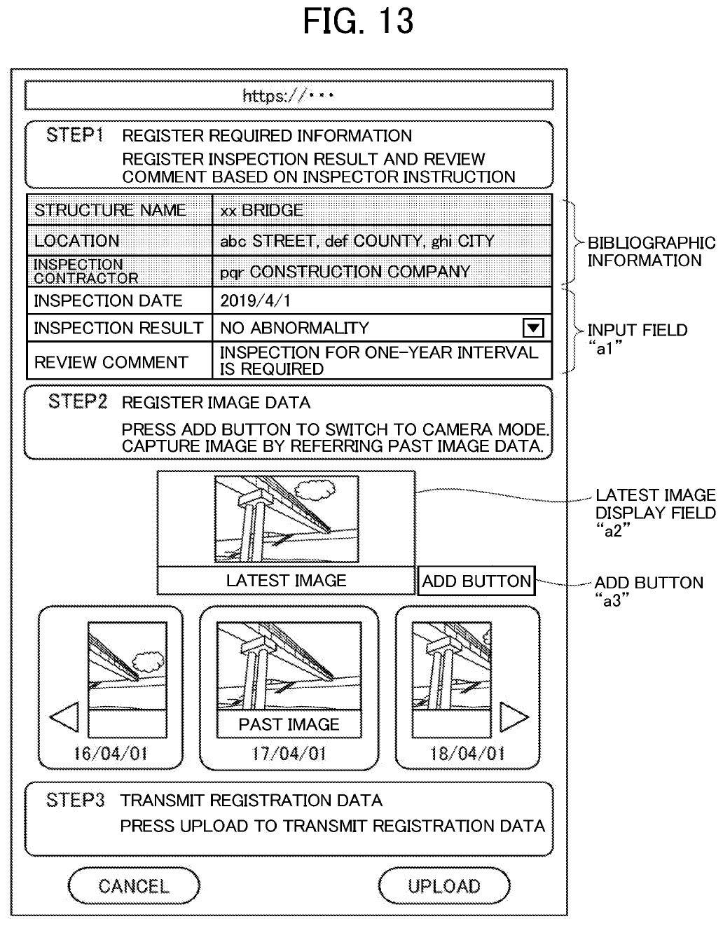

Further, the inspection result management DB 6003 may not employ a table structure illustrated in FIGS. 8A, 8B, and 8C. For example, the inspection result management DB 6003 can store the information source ID, passcode, and data of the inspection result registration screen, such as URL, illustrated in FIG. 13, in association with each other.

As to above described embodiment, when the smart device 2 transmits the information source ID, obtained or acquired from the information service 10 associated with the inspection target Y, to the inspection information management server 6 via the communication network 100 (steps S21 to S25 in FIG. 9), the smart device 2 can receive and display the input item related to the inspection result suitable for the inspection target Y from the inspection information management server 6 (steps S44 and S45 in FIG. 11). With this configuration, the burden on identifying the input item suitable for the inspection target Y can be reduced or decreased for the inspector or the assistant.

Further, as to above described embodiment, the information source 10 is associated with the inspection target Y by attaching the information source 10 on the inspection target Y at the inspection location X (inspection site), and the inspection information management server 6 stores the information source ID (example of identification information) and the past image data of the inspection target Y in association with each other. With this configuration, when the smart device 2 acquires the information source ID from the information source 10 and transmits the acquired information source ID to the data management server 4, the inspection information management server 6 can transmit the past image data of the inspection target Y to the smart device 2. With this configuration, the inspector A and the assistant B can easily acquire the past image data of the inspection target Y, which is the current inspection target, with which the photography composition of the inspection target Y to be captured can be easily determined.

Further, as to above described embodiment, if the inspection target Y is a real estate, such as condominium and apartment, a real estate agent (inspector A, assistant B) can perform an inspection of real estate for checking dirt or damage in a room immediately after moving into the room and immediately after leaving the room, and transmit captured image data of the room captured by using a camera to the inspection information management server 6.

Further, as to above described embodiment, the smart device 2 can acquire not only the information source ID, but also the URL of the access destination, illustrated in FIG. 5A, from the information source 10. With this configuration, the assistant B does not have to consider which URL is required be accessed to register the inspection result of the inspection target Y, with which the assistant B can easily perform the registration of the latest image data of the inspection target Y at the inspection location X (inspection site).

Since the inspection method and the inspection location are different depending on the type of inspection target, such as bridge and tunnel, the input item on the inspection result become different depending on the type of inspection target. Therefore, as to the conventional method, the inspector or assistant has a burden of identifying the input item suitable for the type of inspection target.

As to the above described embodiment, the burden on identifying the input item suitable for the type of inspection target can be reduced.

Further, as to above described embodiment, the inspector A and the assistant B work together while the inspection work of the inspection target Y is being performed by the inspector A, but the smart device 2 can be operated by any one of the inspector A and the assistant B. For example, in a case that the inspector B does not visit the inspection location X, and the inspection work of the inspection target Y is performed by the inspector A alone, the smart device 2 is operated by the inspector A.

Further, as to above described embodiment, the information source ID is information provided by the information source 10 to the communication terminal, such as the smart device 2, and the information source ID is an example of identification information identifying the information source 10, but is not limited thereto. The information source ID is provided by the information source 10, but the information source ID can be any information that can identify a source other than the information source 10. For example, if the information source 10 is a global positioning system (GPS) satellite, the identification information includes, for example, position information based on GPS signal.

Each function of the above-described embodiment can be implemented by one or more processing circuits. The “processing circuit” includes a processor which is programmed to perform each function by software such as a processor implemented by an electronic circuit, and device designed to perform each function described above, such as application specific integrated circuit (ASIC), digital signal processor (DSP), field programmable gate array (FPGA), conventional circuit module, and the like.

Numerous additional modifications and variations are possible in light of the above teachings. It is therefore to be understood that, within the scope of the appended claims, the disclosure of this specification can be practiced otherwise than as specifically described herein. Any one of the above-described operations may be performed in various other ways, for example, in an order different from the one described above.

What is claimed is:

1. A communication terminal communicable with a server for managing inspection information of one or more inspection targets via a communication network, the communication terminal comprising
circuitry configured to:
acquire identification information identifying a particular inspection target from an information source associated with the particular inspection target;
transmit the identification information to the server via the communication network;
receive information on an input item related to an inspection result of the particular inspection target, transmitted from the server based on the identification information;
display the input item on a display; and
receive input information with respect to the input item.

2. The communication terminal according to claim 1,
wherein the circuitry receives the information on the input item based on a type of the particular inspection target.

3. The communication terminal according to claim 2,
wherein the circuitry transmits the identification information including type information indicating the type of the particular inspection target, and the circuitry receives the information on the input item based on the type information indicating the type of the particular inspection target transmitted from the server.

4. The communication terminal according to claim 2,
wherein the circuitry further transmits type information indicating the type of the particular inspection target with the identification information, and the circuitry receives the information on the input item based on the type information indicating the type of the particular inspection target transmitted from the server.

5. The communication terminal according to claim 1,
wherein the circuitry transmits the received input information to the server via the communication network.

6. The communication terminal according claim 1,
wherein the circuitry receives prior image data of the particular inspection target transmitted from the server in response to transmitting the identification information to the server, and the circuitry displays the prior image data of the particular inspection target on the display.

7. The communication terminal according to claim 1,
wherein the information source is associated with the particular inspection target by attaching the information source on the particular inspection target.

8. The communication terminal according to claim 7,
wherein the information source is a seal having quick response (QR) code embedded with the identification information,
wherein the information source is associated with the particular inspection target by attaching the information source on the particular inspection target.

9. The communication terminal according to claim 7,
wherein the information source is any one of an integrated circuit (IC) tag that transmits the identification information, and a beacon transmitter that transmits the identification information.

10. A communication system comprising:
a communication terminal; and
a server, communicable with the communication terminal via a communication network, configured to manage inspection information of one or more inspection targets,
the communication terminal including first circuitry configured to
acquire identification information identifying a particular inspection target from an information source associated with a particular inspection target;
transmit the identification information to the server via the communication network;
receive information on an input item related to an inspection result of the particular inspection target, transmitted from the server based on the identification information;
display the input item on a display; and
receive input information with respect to the input item,
the server including second circuitry configured to
store the identification information and information on the input item in association with each other;
receive the identification information transmitted from the communication terminal via the communication network; and
transmit, to the communication terminal via the communication network, information on a specific input item corresponding to the received identification information, by searching the information on the specific input item.

11. A method of communicating information between a communication terminal and a server for managing inspection information of one or more inspection targets via a communication network, the method comprising;
acquiring identification information identifying a particular inspection target from an information source associated with the particular inspection target;
transmitting the identification information to the server via the communication network;
receiving information on an input item related to an inspection result of the particular inspection target, transmitted from the server based on the identification information;
displaying the input item on a display; and
receiving input information with respect to the input item.
